(19) United States
(12) Patent Application Publication
(10) Pub. No.: US 2012/0030277 A1
(43) Pub. Date: Feb. 2, 2012

(54) PREVIEW PUBLISHING OF REPORTS

(75) Inventors: Lukasz Wladyslaw Pawlowski, Seattle, WA (US); John Edward Gallardo, Woodinville, WA (US); Yunxin Wu, Kirkland, WA (US)

(73) Assignee: Microsoft Corporation, Redmond, WA (US)

(21) Appl. No.: 12/910,726

(22) Filed: Oct. 22, 2010

Related U.S. Application Data
(60) Provisional application No. 61/369,690, filed on Jul. 31, 2010.

(51) Int. Cl. G06F 15/16

(52) U.S. Cl. 709/203; 709/227

(57) ABSTRACT

Described are embodiments directed to providing a preview feature in a report designer that allows modifications to report metadata to be made and previewed accurately. In embodiments, the feature allows a user to open a report to make changes to metadata of the report and have an accurate preview of how the report will look when published on a report publishing server. Embodiments provide for a report publishing server to allocate an in memory location that stores modified metadata of a report. The in memory location allows relative paths and references to sub-reports or data sources in the original report to be accurately reflected in a preview on the client.

### CROSS-REFERENCE TO RELATED PATENT APPLICATIONS

The present application claims priority to U.S. Provisional Patent Application No. 61/369,690 entitled, PREVIEWING PUBLISHING OF REPORTS, filed on Jul. 31, 2010. U.S. Provisional Patent Application No. 61/369,690 is hereby incorporated by reference in its entirety as if set forth herein in full.

### BACKGROUND

Organizations collect and store a large amount of data in databases. This data may be for example employee data or data relevant to a business such as inventory or customer information. In order to present this data in a user friendly fashion, reports can be generated to easily view and analyze the data. Reporting services applications can provide ready-to-use tools and services to help create, deploy, and manage reports for an organization, as well as programming features that enable the customization of the reporting functionality.

Reporting services that include a report designer do not always provide for an easy, efficient, and accurate way to preview changes to reports. For example, if changes are made to a report and a user wishes to preview the report with the changes, some reporting services may require the changed data to be published as a separate report. Furthermore, the previews of a report may not accurately reflect how a report will look when published. Some report publishing servers provide additional features in their server environments that are not reflected in the report file. Thus, previewing a changed report outside of the server environment will not accurately reflect how the report will look when actually published within the server environment.

It is with respect to these and other considerations that embodiments of the present invention have been made. Also, although relatively specific problems have been discussed, it should be understood that embodiments of the present invention should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Described are embodiments directed to providing a preview feature in a report designer that allows modifications to report metadata to be made and previewed accurately. In embodiments, the feature allows a user to open a report to make changes to metadata of the report and have an accurate preview of how the report will look when published on a report publishing server. Embodiments provide for a report publishing server to allocate an in memory location that stores modified metadata of a report. The in-memory location is associated with the same folder as the original report, which allows relative paths and references to sub-reports or data sources stored on the report publishing server to be accurately reflected in a preview on the client.

Embodiments may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures.

FIG. 1 illustrates an embodiment of a system that may be used to implement embodiments.

FIG. 2 illustrates a block diagram of a client and server that may be used in some embodiments.

FIG. 3 illustrates an operational flow for a client with a report designer that provides preview of an edited report consistent with some embodiments.

FIG. 4 illustrates an operation flow for a report publishing server providing information to allow an edited report to be previewed consistent with some embodiments.

FIG. 5 illustrates an operation flow for a client to request a report publishing server to test connection to a data source referenced in a report, consistent with some embodiments.

FIG. 6 illustrates an operation flow for a report publishing server to test a connection to a data source referenced in a report, consistent with some embodiments.

FIG. 7 illustrates a block diagram of a computing environment suitable for implementing embodiments.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

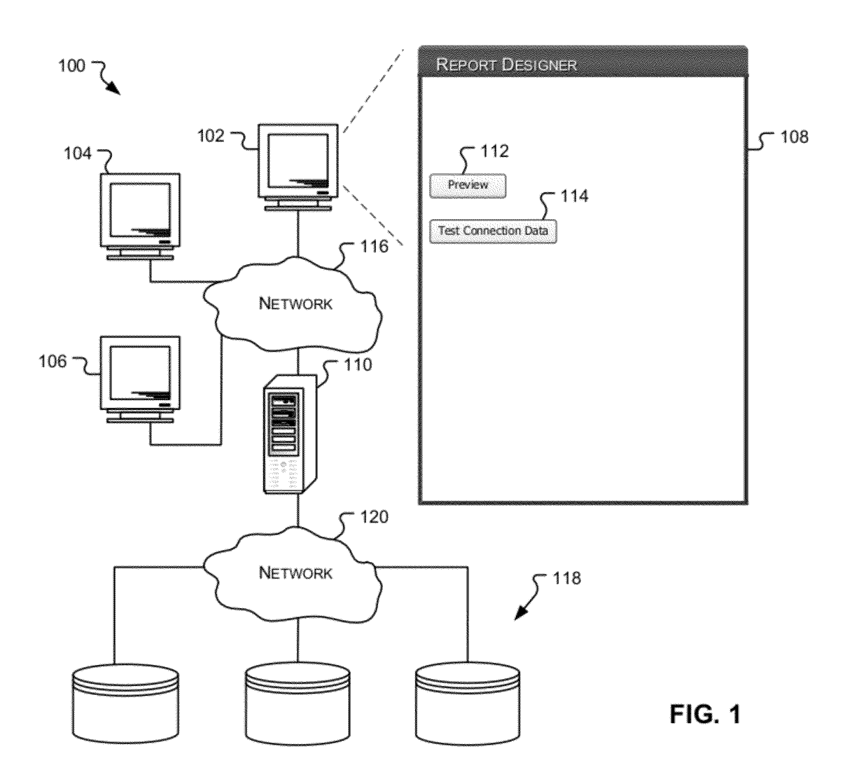

FIG. 1 illustrates a system 100 that may be used to implement embodiments. System 100 includes clients 102, 104, and 106. As shown in FIG. 1, client 102 includes an embodiment of a report designer. The report designer includes a user interface 108 that is used to receive input from a user of client 102. A user may utilize the report designer to design a report that will be published on a report publishing server such as server 110. As shown in FIG. 1, the report designer includes user interface elements such as elements 112 and 114 that a user can select. As described in greater detail below, in embodiments selection of interface element 112 allows a user to preview a report when the user edits report metadata. Also described in greater detail below, in embodiments when a user selects interface element 114, report designer requests a publishing server to test connection data that is used to connect to a data source that stores data to be used in a report. It should be understood that although interface elements are shown displayed together, they may actually in embodiments be displayed in separate windows or panes, within separate toolbars, or separate dialog boxes. The interface elements are shown within the user interface 108 merely for illustrative purposes.

Through network 116, client 102 communicates with server 110. As noted above, once a user has finished designing a report on client 102, the report is then published on report publishing server 110. Report publishing server 110 is also accessible by other clients through network 116, such as client 104 and client 106. Each of these clients may in embodiments include report designers that allow them to create and modify reports. In other embodiments, these clients only include a browser that allows them to view reports that have been published on server 110.

As those with skill in the art will appreciate, reports designed by users on client 102 using the report designer may refer to different data sources where data used to populate the report is stored. For example, databases 118 may store data that can be used to populate reports designed using the report designer on client 102. Using the report designer, a user includes references to the databases 118. When a request to publish a report is sent from client 102 to report publishing server 110, server 110 will interpret the references in the report and populate the report with data from databases 118. In embodiments, server 110 utilizes network 120 to retrieve data from databases 118. In some embodiments databases 118 may be other types of data sources, such as data sources stored locally on server 110.

As those with skill in the art will appreciate, databases 118 may have some security or other protocols that must be followed to access data within databases 118. In these instances, metadata in the report will include connection data necessary to connect to the databases 118. As noted above, in embodiments report designer 114 provides for the server to test the connection data before the report is actually published to server 110. In these embodiments, a user can, while inputting connection data into the report using the report designer on client 102, request that the server test the connection data.

Although some report designers provide for allowing a client to test connection data, embodiments described herein provide for the server to test connection data. In some situations, even if a client can successfully connect to databases 118, server 110 cannot connect to access databases 118, such as for reasons related to the topology of network 120. The inability of report publishing server 110 to connect to databases 118 results in failure to publish the report or an incomplete published report. With the report designer on client 102, the connection data can be tested by the server, and if there are any problems, the problems can be corrected prior to publishing a report.

As described in greater detail below, once a report has been published on server 110, report designer on client 102 can in embodiments be used to modify metadata of the report. In embodiments, the report designer allows modifications to the report to be previewed. The ability to accurately preview modified metadata is effected by having the server 110 publish the report with the modified metadata. Having the preview published, or generated, by the server 110 results in an accurate representation of how the modified report will publish since the server's configurations, infrastructure, and IT settings are used in generating the preview. This results in a more accurate representation of the preview that if the preview was being generated locally on the client, which may have different configurations of infrastructure that do not accurately reflect those of server 110.

The previews are accurate representations of what a report would look like with the changed metadata. In addition, the preview does not interfere with the ability of other clients such as clients 104 and 106 to access the original report. While changes are being made on client 102, users on clients 104 and 106 would see the original report without the changes to the metadata being made on client 102.

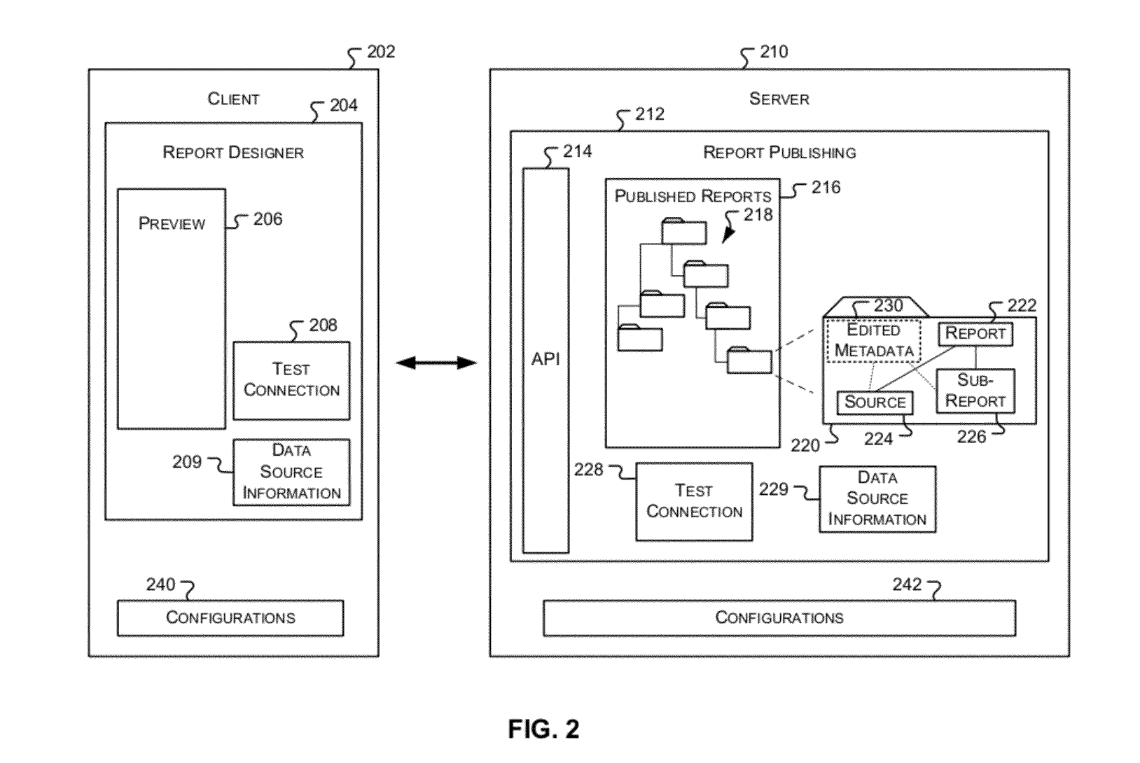

FIG. 2 illustrates a block diagram of a client and server that may be used in some embodiments. Client 202 in embodiments is implemented as client 102 shown in FIG. 1. Server 210 in embodiments is implemented as server 110 shown in FIG. 1.

As shown in FIG. 2, client 202 includes a report designer application 204. Application 204 allows a user to design reports. The reports include metadata that describes the features of the report including information for accessing data sources that store data to be used to populate the report when it is published to report publishing server 210. Additionally, report designer application 204 can be used to edit previously designed reports that are published on server 210. Report designer application 204 includes a preview module 206. Preview module 206 allows a user to preview a report that is being edited. Preview module 206 communicates with server 210 to provide a user with an accurate preview of what a report would look like with the edits being made by a user.

Report designer application 204 also includes a test connection module 208. When a user is designing a report that requires data from a data source, a user can include connection data used to connect to a data source. In other words, a user can include a definition of a data source in a report. If the data source requires credentials to authorize access to the data source, a user can include the necessary credentials within metadata of the report to allow a connection by the server 210 to the data source when the report is published. Test connection module 208 allows the report designer to request that the server 210 test the connection data. As noted above, in some situations, clients 202 may be able to connect to the data source however, server 210 may be unable to. The test connection module 208 allows for any issues to be identified before a report is published.

In some embodiment, the client 202 stores data source information 209 and includes the data source information when it requests the server 210 to test the connection data. The data source information 209 may include information that identifies the location of the data source or credentials for accessing the data source. In other embodiments, client 202 may not have any data source information and the report may merely reference a data source. In these embodiments, test connection module 208 may simply send a request to test connection module 228 on server 210 to test the connection of the data source, and server 210 will use data source information 229 stored on server 210 to test the connection.

As shown in FIG. 2, server 210 includes a report publishing application 212. The report publishing application 212 publishes reports that have been created by report designers such as report designer 204. Application 212 communicates with application 204 to publish reports and also to provide preview information for reports being edited on report designer 204. Report publishing application 212 includes API 214 that is used by report designer 204 to communicate with and request services from report publishing application 212.

Report publishing application 212 stores a number of published reports 216. In the embodiment shown in FIG. 2, the published reports are organized within folders such as folder 220 within a folder hierarchy (or namespace) 218, although other types of organizations are possible. As shown in FIG. 2, report 222 is stored within folder 220. In this embodiment, report 202 includes a number of references to items within folder 220. The items include a data source 224 and a sub report 226. The items may be referred to using relative references.

As noted above, report publishing application 212 also includes test connection module 228 that is used to test connection data. As indicated above, test connection module 208 of application 204 may request the server 210 to test connection data. In the embodiment shown in FIG. 2 the request is handled by the test connection module 228 of report publishing application 212. The test connection module 228 attempts to connect to a data source using data source information provided in the request or stored on server 210.

When a user utilizing report designer application 204 desires to make changes to a report previously published on server 210, she can make a selection to edit the report. The selection is made in embodiments by selecting a user interface button or by some other input made using a user input device. After the selection, the designer application 204 then allows the user to make changes such as editing metadata of the report. As part of editing the metadata of the report, preview module 206 will execute to provide the user with a preview of the edited report. The report designer application 204 sends a request to the report publisher application 212 to create an in memory location where modified metadata is stored. It should be appreciated that in embodiments the in memory location is a logical concept, and not a physical one. An item may not actually be stored in this location, but has a “context location” associated with it, which provides features such as the ability to resolve relative paths.

In one specific embodiment, creating an in memory location is implemented using edit sessions. It should be understood that the use of edit sessions is not the only way to implement the features of the embodiments described herein, and other embodiments are not limited to the use of edit sessions. For example, in some embodiments sessions between client 202 and server 210 are not established. Instead, edited metadata is sent to the server 210 for preview as a single transaction. Edit sessions provide the report designer application 204 the ability to associate the report being edited with a catalog location (e.g., file or folder), thus allowing relative references, stored embedded data source credentials, etc. to work during report preview. As seen in FIG. 2, the location is identified by reference numeral 230. As can be seen, references to source 224 and sub report 226 function properly for the edited metadata item.

It should be understood that reference 230 is shown in FIG. 2 merely for purposes of illustration. The edited metadata 230 is shown in folder 220 to illustrate that previews generated using the edited metadata 230 access data sources and sub reports that may be referenced in report 222. This provides an accurate preview of a report with the edited metadata 230.

Additionally, shown in FIG. 2 are client configurations 240 and server configurations 242. Configurations 240 and 242 include parameters such as security configurations, network configurations etc. As those with skill in the art will appreciate, client configurations 240 are likely to be different than server configurations 242. This highlights one of the features of publishing previews on server 210. Previews published on server 210 will be subject to the configurations 242. As a result, if the server configurations 242 do not allow a report to execute properly, a user will be alerted to the issues because the preview will not execute properly. The user can then make any necessary changes to ensure that server configurations 242 do not interfere with the proper execution of the modified report. In conventional preview mechanisms, which publish previews locally on a client, a user would not be made aware of issues that could be created by server configurations 242 because client configurations 240 may not create the same issues. For example, a report may make a URL call to a network location. Client configurations 240 may allow such calls to be made, whereas server configurations 242 do not. A preview of the report executing on the client would function properly. However, when published on the server, the report would not function properly because the server would not be able to make the URL call. In contrast, the embodiments described herein alert a user to issues that may be created by server configurations 242. The user can then make any necessary changes to avoid the issues created by server configurations 242.

In embodiments, when the report designer application 204 opens a report from the report server, or otherwise determines that a preview should be displayed, it will utilize a report edit session. When previewing the report, the edit session will be used as the basis for the preview operation.

The edit session allows the report publishing application 212 on server 210 to cache data sets used by the report during preview operations. The report publishing application 212 does this automatically for edit sessions. This speeds up the iteration between preview and layout editing operations in report designer application 204. The report designer application 204 is able to explicitly request new data, if desired.

The report publishing application 212 exposes an Edit Session. The Edit Session is a temporary container, for example location 230, created on the server 210 that can be used by the report designer application 204. This container is useful for maintaining consistency of property values and data across multiple preview operations. The container can be associated with a location in the catalog, which allows preview operations to reuse relative references, stored properties like embedded data source credentials (e.g., for source 224), etc. during preview. In embodiments, multiple Edit Sessions may exist for different users and a single user may have multiple outstanding edit sessions, i.e., for different reports being edited. In embodiments, an edit session is associated with one user. These embodiments avoid conflicting editing issues, which may occur if the edit sessions are shared across users. In other embodiments, however edit sessions may be shared across users and mechanisms implemented to avoid conflicting edits by different users.

In embodiments, Edit Sessions can share the same semantics as Execution Sessions (sessions used in originally creating a report). For example, in embodiments:

1) Edit Sessions are managed & expired like Execution Sessions.

2) Edit Sessions have a timeout which can be controlled by an Administrator

a. Each interaction with the Edit Session extends the timeout

b. After the timeout is exceeded, the Edit Session is terminated

3) Edit Sessions are secured to the user who created them.

4) Edit Sessions can be terminated by an API call.

In some embodiments, Edit Sessions are longer lived than Execution Sessions and thus have their own default value for session expiration timeout. Administrators can set the Edit Session timeout.

Edit Sessions in embodiments have a unique identifier determined by the report publishing application 212. The report designer application 204 obtains the identifier when the Edit Session is created and is expected to reuse the identifier when interacting with the session. In some embodiments, the Edit Session identifier is a human readable string; its structure is visible to API consumers.

One embodiment of an Edit Session Identifier (ID) structure is shown below:

|EditId|@|Path|

EditId—a unique identifier

Path—the path to the item (e.g. Folder or Report) associated with the Edit Session

The structure above is merely one example. As those with skill in the art will appreciate, any suitable way for identifying an edit session may be used without limitation.

In embodiments, Edit Session IDs can be used in place of item paths in API calls; APIs on each of the report publishing application 212 and report designer application 204 can specify in embodiments whether they can operate on an Edit Session.

In embodiments, Edit Sessions may follow the following interaction pattern:

1) Edit Session is created

2) Edit Session is populated either during creation, or afterwards though a series of API calls

3) Edit Session is used for preview operations

4) Edit Session is updated through API calls as item edits occur

5) Edit Session is re-used for preview operations

6) Edit Session is terminated either explicitly by the client or after it times-out

To implement Edit Sessions, in some embodiments, a new API call, e.g., CreateReportEditSession is defined for the report publishing application 212. This API allows the user to create an Edit Session. The Edit Session is created with a report definition and is optionally associated with an existing folder (e.g., folder 220) or report catalog item as shown in FIG. 2.

When an Edit Session is associated with a report (e.g., 222), the current properties of the report are reflected in the Edit Session. These include the parameter defaults, data source settings, general properties like description. This is shown by the dashed lines that link 230 to source 224 and sub-report 226.

Although some specific details have been provided above with respect to implementing an in-memory location for use in previewing modified data, it should be understood that the use of Edit Sessions is not the only way to implement the features of the embodiments described herein, and other embodiments are not limited to the use of Edit Sessions. In other embodiments, client 202 may send edited metadata is a transaction to server 210, which then publishes a preview of an edited report and sends preview information back to client 202.

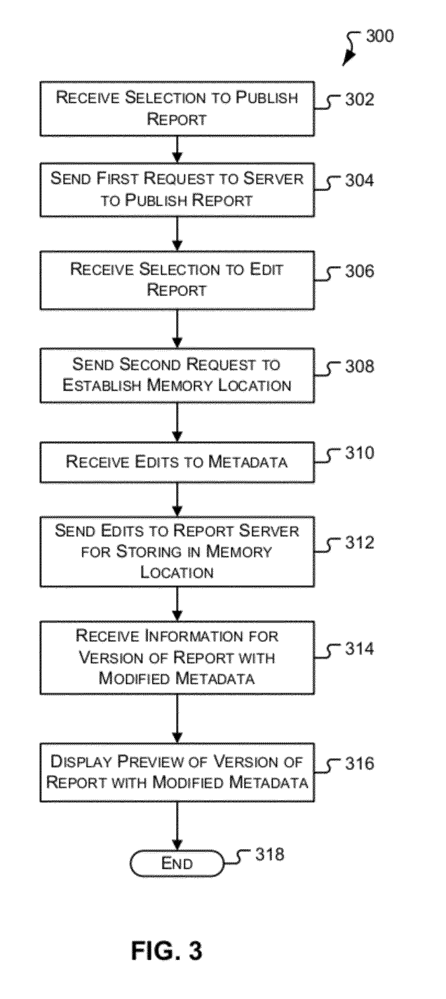

FIGS. 3, 4, 5, and 6 illustrate operational flows 300, 400, 500, and 600 according to embodiments. Operational flows 300, 400, 500, and 600 may be performed in any suitable computing environment. For example, the operational flows may be executed by systems such as illustrated in FIGS. 1 and 2. Therefore, the description of operational flows 300, 400, 500, and 600 may refer to at least one of the components of FIGS. 1 and 2. However, any such reference to components of FIGS. 1 and 2 is for descriptive purposes only, and it is to be understood that the implementations of FIGS. 1 and 2 are non-limiting environments for operational flows 300, 400, 500, and 600.

Furthermore, although operational flows 300, 400, 500, and 600 are illustrated and described sequentially in a particular order, in other embodiments, the operations may be performed in different orders, multiple times, and/or in parallel. Further, one or more operations may be omitted or combined in some embodiments.

Operational flows 300 and 500 may be performed in embodiments by clients that are executing a report designer application such as report designer application 204 (see FIG. 2). Operational flows 400 and 600 may be performed in embodiments by servers that are executing a report publishing application such as report publishing application 212 (see FIG. 2).

Operational flow 300 begins at operation 302 where a selection to publish a report is received. The selection can be received by for example the use of a user interface where a user selects a button after having designed and created a report for publication. Flow 300 passes from operation 302 to operation 304 where a first request is sent to a server to publish the report.

Operational flow 300 then flows to operation 306 where a selection to edit the report is received. In this embodiment, the report to be edited was previously published using operations 302 and 304. Operational flow 300 passes from operation 306 to operation 308 were a second request is sent to the server to establish an in memory location to store modified metadata for the report. As described above with respect to FIG. 2, this can be implemented in some embodiments by the client requesting the establishment of an Edit Session. However in other embodiments, this is implemented in different ways.

At operation 312 edits to the report are received and at operation 314 the edits are sent to the in memory location. Flow then passes to operation 316 where information from the server for displaying the preview of a report is received by the client. The preview information is used to display a preview of a version of the report with the modified metadata. As those with skill in the art will appreciate, operations 314, 316 and 318 are repeated in embodiments each time metadata from a report is edited. In other words, operations 314, 316, and 318 in embodiments work in a loop. Moreover, a user is not required to only perform a single preview but may have more than one preview, i.e., a plurality of previews.

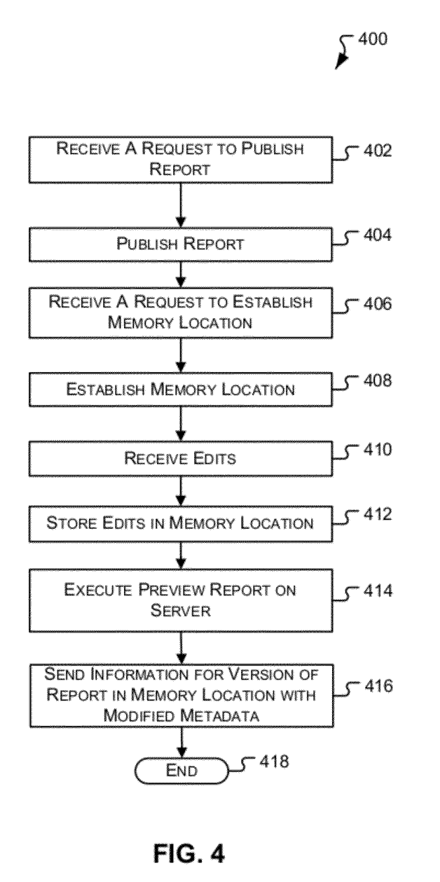

Referring now to flow 400 shown and FIG. 4, it begins at operation 402 where a request to publish a report is received. In response to operation 402, at operation 404 the request is published, i.e., the report is populated with data from defined data sources and is formatted according to the report definition. At operation 406, the server receives a request to establish a memory location for storing edits to metadata of a report. In this embodiment, the report was previously published using operations 402 and 404.

In response to having received the request to establish a memory location, the location is established at operation 408. As noted above with respect to FIG. 2 establishing a memory location can be implemented using an Edit Session. In other embodiments however the memory location is merely associated with a folder or other file system location without the specific implementations of an Edit Session as described above with respect to FIG. 2.

After the memory location is established, edits are received at operation 410. The edits received at operation 410 are then stored in the memory location at operation 412. At operation 414, the edits are executed on the server to generate the preview information.

In one embodiment, operation 414 may be implemented by creating an in-memory temporary representation of a namespace, such as namespace 218 (FIG. 2.). An edit session may be assigned to a path within the temporary namespace. In some embodiments, the temporary representation of the namespace and the actual namespace are merged. In other words, the temporary namespace is overlayed over the actual namespace. The execution of the preview report then occurs as if the preview report were the actual report.

At operation 416, information that allows the edited report to be previewed on the client based on the modified metadata is sent from the server to the client. Flow then ends at 418.

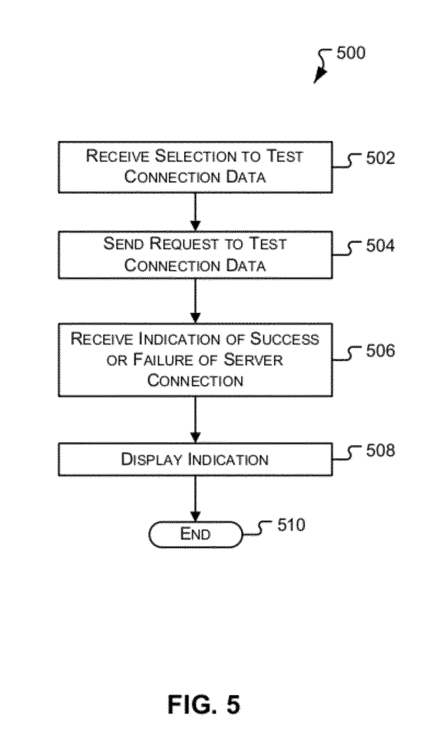

Referring now to FIG. 5, flow 500 begins at operation 502 where a selection to test connection data is received. It should be understood that operation 502 does not necessarily have to follow any of the previous operations described with respect to FIG. 3 (302-318). Following operation 502 at operation 504 a request is sent to the server to test connection data. In some embodiments, the request may include data source information such as credentials or data source location information for the server to use in testing the connection. In other embodiments, the request may simply include a reference to the data source and the data source information is stored on the server. The server can then use the data source information stored on the server to test the connection.

At operation 506 the client receives an indication of success or failure of the server connection. Finally at operation 508 an indication of whether the connection data was successful or not is displayed to a user. Flow 500 ends at 510.

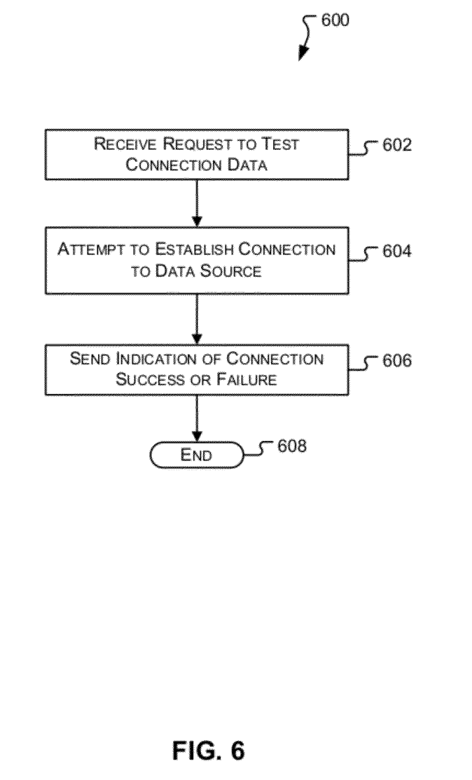

FIG. 6 illustrates flow 600 which begins at operation 602 where a request to test connection data is received from a client. It should be understood that operation 602 does not necessarily have to follow any of the previous operations of FIG. 4 (402-414). Following operation 602 flow passes to operation 604 where the server attempts to establish a connection to the data source using connection data. In some embodiments the connection data may be included in the request received at operation 602. In other embodiments, the connection data may be stored on the server and the request merely includes a reference to the data source. At operation 606 the server sends an indication to the client about whether it successfully connected to the data source. Flow 600 ends at 608.

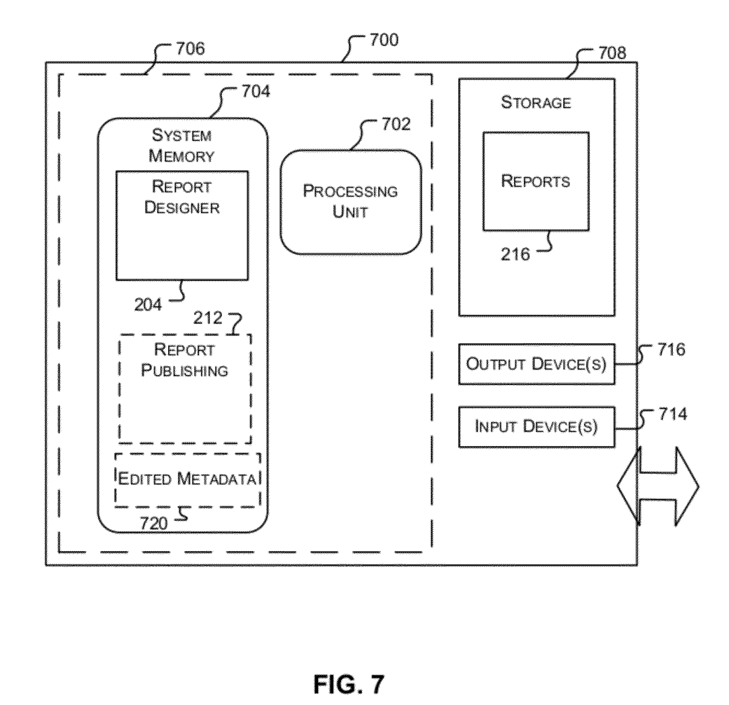

FIG. 7 illustrates a general computer system 700, which can be used to implement the embodiments described herein. The computer system 700 is only one example of a computing environment and is not intended to suggest any limitation as to the scope of use or functionality of the computer and network architectures. Neither should the computer system 700 be interpreted as having any dependency or requirement relating to any one or combination of components illustrated in the example computer system 700. In embodiments, system 700 may be used as a client and/or server described above with respect to FIGS. 1 and 2.

In its most basic configuration, system 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. System memory 704 stores applications that are executing on system 700. For example, memory 704 may store report designer application 204 described above with respect to FIG. 2. In other embodiments, memory 704 may store a report publishing application 212 such as described with respect to FIG. 2. Memory 704 may also include the in memory location 720 where edited metadata is stored for executing a preview of an edited report.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage, and non-removable storage 708 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 714 such as a keyboard, a mouse, a pen, a sound input device, a touch input device, etc. Output device(s) 716 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Reference has been made throughout this specification to “one embodiment” or “an embodiment,” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

We claim:

1. A computer implemented method of previewing reports in a reporting service application, the method comprising:
receiving at the client a selection to edit metadata of a report published in a server environment on a report publishing server;
in response to receiving the selection to edit metadata, sending a request to the report publishing server to create a memory location to store modified metadata of the report, wherein the memory location provides characteristics of the server environment that allows modified metadata to be tested;
receiving at the client edits to the metadata of the report to create the modified metadata;
in response to receiving the edits to the metadata, sending the modified metadata to the report publishing server for storing in the memory location;
displaying at the client a preview of a version of the report created using the modified metadata stored in the memory location.

2. The method of claim 1, wherein the modified metadata in the memory location does not interfere with a second client accessing the report.

3. The method of claim 1, wherein the sending the request comprises sending a request to establish an edit session.

4. The method of claim 1, further comprising prior to the receiving at the client a selection to edit the metadata of the report;
receiving at the client a selection to publish the report;
sending a first request to the report publishing server to publish the report in the server environment.

5. The method of claim 1, further comprising receiving at the client a selection to test connection data used to connect to a data source referred to in the report, wherein at least a portion of the metadata includes the connection data.

6. The method of claim 5, in response to the receiving the selection to test connection data, sending a request to the report publishing server to test the connection data used to connect to the data source.

7. The method of claim 6, wherein the request includes credentials for connecting to the data source.

8. The method of claim 6, wherein the request includes a reference to data source connection information.

9. A computer implemented method of providing preview data for reports published from a reporting service application, the method comprising:
receiving a request at a report publishing server to create a memory location to store modified metadata of a report, wherein the report is published in a server environment on the report publishing server, and wherein the memory location provides characteristics of the server environment that allows modified metadata of the report to be tested; and
receiving at the report publishing server the modified metadata from a client; and
storing the modified metadata in the memory location.

10. The method of claim 9, wherein the modified metadata in the memory location does not interfere with a second client accessing the report.

11. The method of claim 9, wherein the receiving the request comprises receiving a request to establish an edit session.

12. The method of claim 9, further comprising prior to the receiving the request:
receiving a first request at the report publishing server to publish the report in the server environment.

13. The method of claim 9, receiving a request at the report publishing server to test connection data used to connect to a data source referred to in the report, wherein at least a portion of the metadata includes the connection data.

14. The method of claim 9, testing the connection data by sending a request to connect to the data source.

15. The method of claim 9, further comprising, executing the report with the modified metadata to generate preview information.

16. The method of claim 9, further comprising, sending the preview information to the client.

17. A computer readable storage medium storing computer executable instructions that when executed perform a method of testing connection data referenced in a report, the method comprising:
receiving a request from a client at a report publishing server, wherein the request provides data source information;
attempting to establish a connection with the data source; and
sending an indication to the client regarding whether a connection to the data source was established.

18. The computer readable storage medium of claim 17, wherein the request from the client includes credentials for establishing a connection with the data source.

19. The computer readable storage medium of claim 19, wherein the attempting comprises using the credentials.

20. The computer readable storage medium of claim 17, wherein the attempting comprises using credentials stored at the publishing server.
